(19) United States
(12) Patent Application Publication
(10) Pub. No.: US 2007/0212503 A1
(43) Pub. Date: Sep. 13, 2007

(54) MULTI-MATERIAL CONTAINER

(75) Inventors: Charles WATLING, Raleigh, NC (US); Nitin GOKHALE, Richmond Heights, OH (US)

Correspondence Address: SCHNADER HARRISON SEGAL & LEWIS, LLP, 1600 MARKET STREET, SUITE 3600, PHILADELPHIA, PA, 19103, US

(73) Assignee: BWAY CORPORATION, Raleigh, NC (US)

(21) Appl. No.: 11/675,107

(22) Filed: Feb. 15, 2007

Related U.S. Application Data
(60) Provisional application No. 60/780,460, filed on Mar. 7, 2006.

(51) Int. Cl. B29C 45/00; B32B 27/08

(52) U.S. Cl. 428/35.7; 264/255; 264/328.8

(57) ABSTRACT

A container, customized to defined specifications, and a method of creating the container are disclosed. Container specifications are provided and evaluated against attributes of various plastic materials, such as polypropylene and polyethylene. A core material and one or more skin materials and thicknesses of each are chosen such that the combination of materials and thicknesses provides the defined specifications. The one or more skin materials are injected into a container mold one at a time. The core material is then injected into the container mold so that the core material is substantially surrounded by the one or more skin materials.

This application is based on, and claims priority to, U.S. provisional application having Ser. No. 60/780,460, having a filing date of Mar. 7, 2006, entitled, Multi-Material Pail.

### FIELD OF THE INVENTION

The invention generally relates to plastic containers for industrial and commercial use.

### BACKGROUND OF THE INVENTION

Standard 1-7 gallon pails are typically formed from high density polyethylene (HDPE) in North America. HDPE is easily moldable, provides good cold impact strength, and is readily available, however, there are other materials from which a pail may be formed, such as polypropylene (PP). Forming a pail of entirely PP will allow you to run at a lighter weight because PP has superior stack and impact strength to HDPE, however, this is often not an option because of its poor cold impact strength. Various PP material blends can remedy some of these problems, but are usually more costly than the single composition materials. Accordingly, a container having performance characteristics of several materials that are not all contained in a single material is desirable.

### SUMMARY OF THE INVENTION

Embodiments of the invention provide a container, customized to defined specifications, and a method of creating the container. Container specifications are provided and evaluated against attributes of various plastic materials, such as polypropylene and polyethylene. Specifications can be provided in discrete amounts, with or without designated tolerances, or can be provided as ranges of quantities. A core material and one or more skin materials and thickness of each are chosen such that the combination of materials and thicknesses provides the defined specifications. The one or more skin materials are injected into a container mold one at a time. The core material is then injected into the container mold so that the core material is substantially surrounded by the one or more skin materials. Illustrative specifications include wall thickness, stack strength, impact strength and suitability for the intended contents.

In an exemplary embodiment of the invention, the core material is a polypropylene and the skin material is a high density polyethylene. The invention is particularly well suited for formation of pails having thicknesses in the range of about 70 mil to about 100 mil, such as 5 gallon pails used for paints, constructions materials, solvents, etc. Advantageously, such pails can be created that have a wall thickness of approximately 90 mil or less with a stack strength of 3600 lbs or more.

### DESCRIPTION OF THE DRAWINGS

The invention is best understood from the following detailed description when read with the accompanying drawings.

FIG. 1 depicts a dual-material pail according to an illustrative embodiment of the invention.

FIG. 2 depicts a co-injection apparatus that can be used to create containers according to illustrative embodiments of the invention.

### DETAILED DESCRIPTION OF THE INVENTION

Embodiments of the invention provide a container having a core material surrounded by one or more skin layers. Each material provides different performance characteristics to the container. In this manner, the pail benefits by having desired qualities from each material that may not be present in an individual material.

The invention lends itself to injection molding, and therefore, thermoplastic materials are suitable. The containers can be formed of commodity plastics, engineering grade plastics, or a combination thereof. Commodity thermoplastic materials include, for example, polyethylene (low density/branched, medium density, high density and ultra high density), polypropylene and polystyrene. Engineering grade thermoplastic materials include, for example, polycarbonate, nylon, acetal and acrylic. By knowing the attributes of each material, a combination of materials can be selected to form a container that exhibits desired properties. Illustrative attributes of the materials mentioned above are as follows:
Polyethylene: economical
   light weight
   ease of processing
   available in food grades
   flexible
   strong
   superior electrical insulation
   moisture resistant
   chemical resistant
   poor UV resistance
   does not easily bond
   cracks relatively easily
Polypropylene: strong
   flexible
   abrasion resistant
   high impact strength
Polystyrene: economical
   transparent
   flammable
   brittle
   strong
Polycarbonate: high impact strength
   transparent
   self-extinguishing
   not solvent resistant
Nylon: strong
   self-lubricating
   chemical resistant
   absorbs moisture
   dimensionally unstable
   expensive
Acetal: Wear resistant
   Dimensionally unstable
   High chemical resistance
   Moisture resistant
   Can release toxic components
   High UV degradation
Acrylic: Highly transparent
   Good electrical insulation
   Cracks easily
   Superior weather resistance

As used herein, “pail” includes containers of any shape and size. Many embodiments of the invention, however, are particularly applicable to 1-7 gallon pails, such as used for building materials, food, paint, oils, and chemicals, and more particularly applicable to 5 gallon pails.

The materials selected may lower the cost of producing a pail while maintaining the structural quality and performance of the pail. The pail weight may also be optimized by proper material selection.

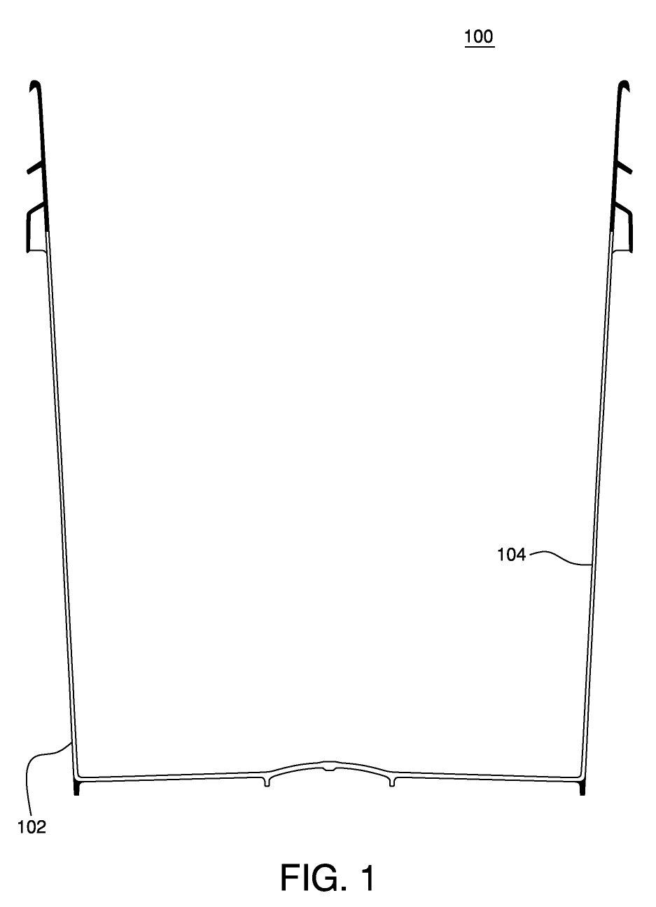

A cross section of a pail according to an illustrative embodiment of the invention is depicted in FIG. 1. A pail 100 has a skin 102 disposed around a core 104. In this particular embodiment the core extends to near the rings of the pail. Depending, for example, on the pail dimensions and the manufacturing equipment, the core material may extend to various heights of the pail wall, or be contained in only certain portions of the pail. This can affect such criteria as weight and strength for various portions of the pail.

Although a dual-material pail can provide desired performance characteristics, multi-material pails may also be desirable. The multiple materials may be within one another or in different portions of the pail. These may include, for example:
a single skin material disposed around a plurality of core materials;
single core material within a plurality of skin materials; and
a plurality of skin materials within a plurality of core materials.

In an illustrative embodiment of the invention, a 90 mil pail is constructed with a PP core and a HDPE skin. This reduces the weight of the pail as compared to one consisting exclusively of HDPE and provides much better cold impact strength than a pail consisting solely of PP. Other pail thicknesses are within the spirit and scope of the invention. Illustrative pail thickness ranges are between about 60 mil and 125 mil, about 70 mil and 100 mil, and about 80 mil and 90 mil.

In an exemplary embodiment of the invention a minimum of 40% of the traditional material used in an open head pail is replaced with something less expensive that enhances performance while making the container lighter. Traditional materials are generally homopolymer, HDPE, and PP. Various grades of material can be used, such as regrind, reprocessed and prime can be used. Illustrative core materials include, but are not limited to, HDPE prime, with various melt indexes HDPE regrind, PP prime, PP reprocess, and HDPE homopolymer.

The choice of material depends, at least in part, on the aesthetics and performance criteria of the final product. As to aesthetics, HDPE regrind, PP reprocess may have contamination of dark colors, and therefore, can only be used to manufacture black or dark/opaque colored products. If regrind or reprocessed material is used as a core material the skin can then be a variety of colors and gives the manufacturer and the purchaser more options.

Illustrative combinations of core and skin materials include, but are not limited to:
HDPE skin (white or any other color)+PP Regrind
HDPE skin (white or any other color)+HDPE Regrind
HDPE skin (white or any other color)+PP Prime
HDPE homopolymer skin (white or any other color)+PP Prime
HDPE homopolymer skin (white or any other color)+HDPE homopolymer regrind
HDPE skin (white or any other color) with a HDPE regrind core.

Experimental results for various criteria are presented in the chart below.

Testing Results on Combinations

| | | | Ambient | | | |
|---|---|---|---|---|---|---|
| | | Stack | Drop | Freezer Drop | | |
| Skin | Core | Strength | FOB** | FOB** | FOS** | ESCR* |
| HDPE (white | HDPE regrind | 3172 | Passed | Passed | Passed | Testing |
| color) | | | | | | |
| HDPE (white | PP regrind | 3480 | Passed | Passed | Passed | Passed |
| color) | | | | | | |
| HDPE | PP Prime | 4202 | Passed | Passed | Passed | 1 failure |
| homopolymer | | | | | | |
| (white color) | | | | | | |
| HDPE (white | PP Prime | 4284 | Passed | Passed | Passed | Passed |
| color) | | | | | | |
| HDPE | PP Prime | 4324 | In testing | In Testing | In Testing | Testing |
| homopolymer | | | | | | |
| (white color) | | | | | | |

*ESCR refers to environmental stress cracking
**FOB and FOS are methods of drop testing. “FOB” is flat on bottom and “FOS” is flat on side.

PP Prime core with HDPE and HDPE homopolymer skin have higher stack strength over all HDPE homopolymer pails tested. HDPE regrind did not have acceptable aesthetics due to visible contamination on pail sidewall.

### Cost Saving Opportunities

Cost can be a factor or specification upon which material choices are made. Cost differentials between different grades of materials and between different types of materials can be considered. For example, reprocessed or regrind material is generally cheaper than prime materials. PP is typically more expensive than HDPE, however, at times the reverse can be true. Accordingly, container compositions can be adjusted to targeted costs. The compositions can be re-evaluated when to accommodate for price changes of raw materials.

### Testing Results for HDPE Prime Skin (gray color)+HDPE Regrind

The stack strength in all core percentages crossed the standard pail stack strength of 3600 pounds force. The process was modified by lowering the transfer position, so that most of the material is injected in the high injection pressure stage and less of packing of the core material is seen on the bottom of the pail. This helps immensely in reducing the amount of scraping the core does to the skin on the bottom ⅓ of the pail sidewall.

The core contamination was seen after crossing the core percentage beyond 60%. This contamination was seen above the beam along the beam ribs. Contamination means bleed through of the core material into the skin material, this can be controlled at this point if we run the core material below 60%.

Critical Process and Product Parameters

### Average Cycle Time 19.5 Seconds

Recovery Time: 5.5-7.5 sec (standard MM 550 recovery: 8-9 sec)
Specifications—satisfied all corporate specifications on the product

### Recovery time was found to be far better than the standard MM 550 recovery times.

Additional Embodiments of the Invention may have the Following Features:
The addition of Talcum powder, preferably in the core, to improve stack strength: talc traditionally is known to improve the stack strength of the plastic product if used as an additive. This, however, gives a sable pearl shade to the final product. Having this in the core increases the chances of stack strength improvement without loosing any aesthetics of the final product.
Blow mold resin blended with HDPE for improved stack as well as impact strength.
Rubber compound modification for improved impact strength.

In a particular embodiment of the invention, the two materials are molded at the same time. This can be accomplished by a device such as that which is disclosed in U.S. Pat. No. 6,627,134 to Joel Thomson, entitled Apparatus for Molding Multilayered Articles, issued Sep. 30, 2003.

The container is preferably formed in a single molding cycle, wherein a molding cycle is defined as the period that includes clamping or closing the mold; injection of the two or more materials (skin and core); cooling or hardening of the plastic within the mold; and ejection or removal of the container from the mold.

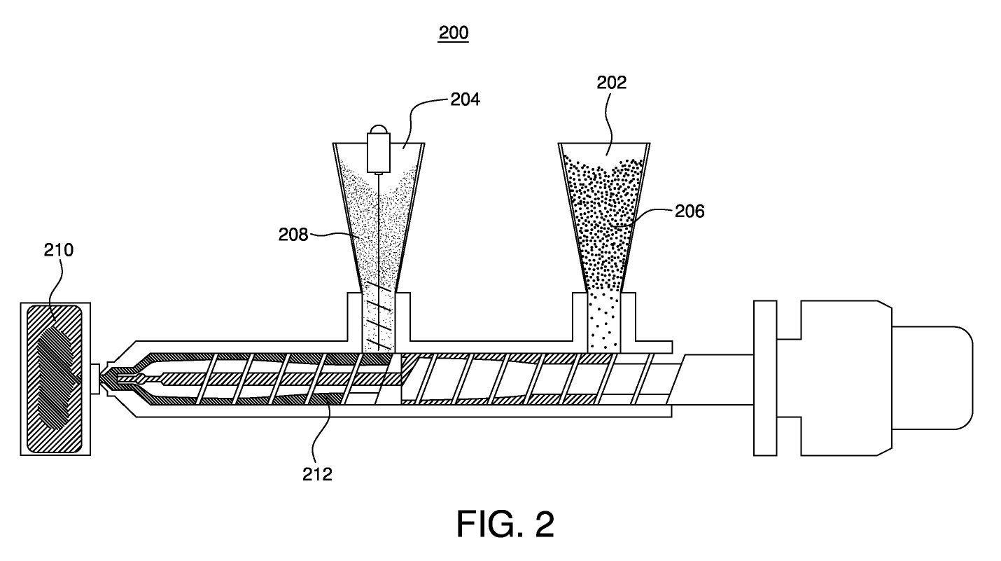

FIG. 2 depicts a prior art illustrative molding apparatus 200 that can be used to form containers according to illustrative embodiments of the invention. A pair of hoppers 202, 204 contain skin material 206 and core material 208, respectively. The material is heated to a molten state for injection into a mold 210. The molten materials are pushed into the closed mold 210 by screw 212. This illustrative apparatus allows the materials to be injected in the same molding cycle. Additional layers can be incorporated into the container with appropriate apparatus.

The invention may be embodied in a variety of ways, for example, a system, method, product, etc.

Embodiments of the invention provide methods for customizing a container to defined specifications. Container specifications are provided, such as, wall thickness, stack strength, impact strength, size and any other quantities and materials described herein. A core material, one or more skin materials and the thickness of each is chosen such that the combination of materials and thicknesses provides the defined specifications. It is noted that the thickness of the core and skin materials can vary throughout the container. The intended contents can also be specified so the integrity of materials with respect to the contents can be taken into consideration. The one or more skin materials are injected into a container mold one at a time. The core material is injected into the pail mold so that the core material is substantially surrounded by the one or more skin materials. Preferably the skin and core materials are polymers, such as described above.

A particularly challenging container to create is one with a stack strength greater than about 3600 lbs and a wall thickness of less than 90 mil. To the best of the inventors' knowledge, this has not been achieved in a plastic container, particularly in a cost effective manner and with good low temperature performance. Illustrative wall thickness to stack strength ratios are less than about 0.024 mil/lbs and less than about 0.023 mil/lbs.

Core loading will vary, but will depend at least in part on the specifications of the container. Appearance may also be a factor in choosing components and thicknesses. For example, if the skin is too thin, the core material may bleed through to the skin. For most applications the core loading is between about 35% and about 65%. Additional illustrative core loading ranges are about 30% to about 70% and about 40% to about 50%.

In a preferred embodiment of the invention, additional skin material is injected into the mold after the core material injection is completed to fully surround the core material by the skin material. For certain configurations, specifications, and/or methods, the core material may not be fully encapsulated by the skin material at the bottom of the container after the core material is injected into the mold. Therefore, it is sometimes necessary and/or desirable to add skin material after the final core material injection.

Embodiments of the invention include a method of forming a multi-material container having a polymer core and at least one polymer skin disposed around the core, wherein the ratio of wall thickness to stack strength is less than about 0.024. (Additional illustrative ratios are provided above.)

Various combinations of materials are within the spirit and scope of the invention. For example, the core may be a polypropylene material and one or more of the skin materials can be a high density polyethylene. Any other combinations of the materials described above can be used for the core and skin materials.

As mentioned above, the ability to produce a container with walls thinner that conventional container of the same durability and strength is a significant advantage of embodiments of the invention. Accordingly, methods of the invention can provide this feature in numerous ways and for various types of containers. In a particular embodiment of the invention, the container has a polymer core with one or more polymer skins disposed around it, a wall thickness less than about 100 mil, and a stack strength greater than about 3600 lbs. In a further embodiment of the invention the stack strength is greater than about 3800 lbs.

While the invention has been described by illustrative embodiments, additional advantages and modifications will occur to those skilled in the art. Therefore, the invention in its broader aspects is not limited to specific details shown and described herein. Modifications, for example, to the combinations of materials and pail size and thicknesses, may be made without departing from the spirit and scope of the invention. Accordingly, it is intended that the invention not be limited to the specific illustrative embodiments, but be interpreted within the full spirit and scope of the appended claims and their equivalents.

Claimed is:

1. A method of customizing a container to defined specifications comprising:
providing container specifications;
choosing a core material and one or more skin materials and thickness of each such that the combination of materials and thicknesses provides the defined specifications;
injecting the one or more skin materials into a container mold one at a time; and
injecting the core material into the container mold so that the core material is substantially surrounded by the one or more skin materials.

2. The method of claim 1 wherein the specifications include wall thickness.

3. The method of claim 1 wherein the specifications include stack strength.

4. The method of claim 1 wherein the core material and one or more skin materials are polymers.

5. The method of claim 4 wherein the core material is a polypropylene.

6. The method of claim 4 wherein at least one of the one or more skin materials is a high density polyethylene.

7. The method of claim 4 wherein the core material is a polypropylene and at least one of the one or more skin materials is a high density polyethylene.

8. The method of claim 1 wherein the specifications include a wall thickness between about 70 mil and about 100 mil.

9. The method of claim 1 wherein the specifications include a stack strength of greater than about 3600 lbs.

10. The method of claim 1 wherein the ratio of wall thickness to stack strength is less than about 0.024.

11. The method of claim 10 wherein the ratio of wall thickness to stack strength is less than about 0.023.

12. The method of claim 1 wherein the container is a pail having a capacity of between about 1 gallon and about 7 gallons.

13. The method of claim 12 wherein the container is a pail having a capacity of about 5 gallons.

14. The method of claim 1 comprising:
providing a core loading between about 35% and about 65%.

15. The method of claim 1 wherein the specifications include impact strength.

16. The method of claim 1 further comprising injecting additional skin material into the mold after the core material injection is complete so the core material is fully surrounded by the skin material.

17. A multi-material container comprising:
a polymer core;
at least one polymer skin disposed around the core:
wherein the ratio of wall thickness to stack strength is less than about 0.024.

18. The container of claim 17 wherein the core material is a polypropylene.

19. The container of claim 17 wherein at least one of the one or more skin materials is a high density polyethylene.

20. The container of claim 17 wherein the core material is a polypropylene and at least one of the one or more skin material is a high density polyethylene.

21. The container of claim 17 wherein the wall thickness is between about 70 mil and about 100 mil.

22. The container of claim 17 wherein the stack strength is greater than about 3600 lbs.

23. The container of claim 17 wherein the ratio of wall thickness to stack strength is less than 0.023.

24. The container of claim 17 wherein the container is a pail having a capacity of between about 1 gallon and about 7 gallons.

25. The container of claim 17 wherein the container is a pail having a capacity of about 5 gallons.

26. The container of claim 17 comprising a core loading between about 35% and about 65%.

27. A multi-material container comprising:
a polymer core;
one or more polymer skins disposed around the core;
wherein the wall thickness is less than about 100 mil; and
the stack strength is greater than about 3600 lbs.

28. The container of claim 27 wherein the core material is a polypropylene.

29. The container of claim 27 wherein at least one of the one or more skin materials is a high density polyethylene.

30. The container of claim 27 wherein the core material is a polypropylene and at least one of the one or more skin material is a high density polyethylene.

31. The container of claim 27 wherein the stack strength is greater than about 3800 lbs.

32. The container of claim 27 wherein the ratio of wall thickness to stack strength is less than 0.023.

33. The container of claim 27 wherein the container is a pail having a capacity of between about 1 gallon and about 7 gallons.

34. The container of claim 27 wherein the container is a pail having a capacity of about 5 gallons.

35. The container of claim 27 comprising a core loading between about 35% and about 65%.

36. A method of customizing a container to defined specifications comprising:
(a) providing a targeted cost of container materials and one or more additional container specifications;
(b) choosing container materials including a core material and one or more skin materials and thickness of each such that the combination of materials and thicknesses provides the defined specification(s) and the targeted cost;
(c) forming the container so the core material is substantially surrounded by the one or more skin materials; and
(d) performing step b again when one or more container material costs change.
